(19) United States
(12) Patent Application Publication
(10) Pub. No.: US 2026/0231017 A1
(43) Pub. Date: Aug. 6, 2026

(54) POWER SAVE MECHANISM FOR AP COMMUNICATING WITH MULTI-LINK OPERATION (MLO) CLIENT DEVICES

(71) Applicant: HEWLETT PACKARD ENTERPRISE DEVELOPMENT LP, Spring, TX (US)

(72) Inventors: Omar El Ferkouss, St. Laurent (CA); Mohd Shahnawaz Siraj, San Jose, CA (US); Andre Beaudin, St. Laurent (CA); Jianpo Han, Beijing (CN)

(21) Appl. No.: 19/046,704

(22) Filed: Feb. 6, 2025

(51) Int. Cl. H04W 52/02; H04L 1/1812; H04L 5/00

(52) U.S. Cl. CPC H04W 52/0206; H04L 1/1812; H04L 5/0053

(57) ABSTRACT

An example method for managing power-save states of a plurality of wireless links between an access point (AP) and a client device operating in a Multi-Link Operation (MLO) mode is presented. The AP identifies a first set of wireless links over which the client device is unresponsive to a first set of data packets and a second set of wireless links over which the client device is responsive to the first set of data packets. Then, the AP retransmits the first set of data packets over the first set of wireless links, and transmits a second set of data packets over the second set of wireless links. Further, in response to determining that a first count of retransmissions over the first set of wireless links has reached a first threshold value, the AP may configure the client device in a dummy power-save state for the first set of wireless links.

### BACKGROUND

The wireless-fidelity (Wi-Fi) standards such as the Institute of Electrical and Electronics Engineers (IEEE) 802.11be (also known as Wi-Fi 7) generally promise to significantly boost the speed and stability of wireless connections while offering lower latency and seamlessly manage an increased number of connections compared to the prior Wi-Fi Standards. In particular, IEEE 802.11be introduced a feature-Multi-Link Operation (MLO) that allows devices to simultaneously utilize multiple frequency bands (e.g., 2.4 gigahertz (GHz), 5 GHZ, and 6 GHZ) to enhance overall performance, reliability, quality of service, efficiency of wireless communication with reduced latency. These features collectively improve the overall user experience and support the growing demands of modern wireless applications.

### BRIEF DESCRIPTION OF THE DRAWINGS

One or more examples in the present disclosure are described in detail with reference to the following Figures. The Figures are provided for purposes of illustration only and merely depict examples.

FIG. 1 depicts an example networked system in which various of the examples presented herein may be implemented.

FIG. 2 depicts a block diagram of an access point.

FIG. 3 depicts a flowchart of an example method for managing power-save states for a plurality of wireless links between an AP and a client device.

FIG. 4 depicts a flowchart of another example method for managing power-save states for a plurality of wireless links between an AP and a client device.

FIG. 5 depicts a flowchart of an example method for managing a client device with one or more wireless links operating in a dummy power-save state.

FIG. 6 depicts a block diagram of an example computing system.

The Figures are not exhaustive and do not limit the present disclosure to the precise form disclosed.

### DETAILED DESCRIPTION

The 802.11be standard, commonly known as Wi-Fi 7, introduces several features designed to enhance wireless communication performance significantly. Among these advancements are faster data rates and the utilization of wider channels, which contribute to the increased capacity and efficiency of the network. One of the most notable new features in Wi-Fi 7 is Multi-Link Operation (MLO). Multi-Link Operation (MLO) allows Wi-Fi client devices such as smartphones, laptops, and other connected devices) to simultaneously establish and use multiple connections across different frequency bands (e.g., 2.4 GHZ, 5 GHZ, and 6 GHZ). This capability enables bandwidth aggregation from multiple links, resulting in higher overall throughput and improved network performance.

While the 802.11be standard and its MLO feature bring significant performance improvements to Wi-Fi networks, they also introduce new challenges for access points (APs), such as, but not limited to effective management of client device's states, power management, and resource allocation. For instance, APs may face challenges in tracking the states of each client device across multiple links. This entails maintaining synchronization and coordination between different frequency bands to ensure seamless communication. Also, the APs need to optimize power consumption while maintaining multiple active links, balancing performance, and energy efficiency.

Before the introduction of the IEEE 802.11be standard, the APs used a common mechanism to manage scenarios where a client device went to sleep mode without notifying the AP or unexpectedly disappeared. In such cases, the AP would assume that the client device is in a power-save state and periodically sends probes to the client device. If the client device responds to the probes, the AP maintains the connection with the client device; if not, the AP would clean up the client device's state after a predefined time. For instance, in one known implementation, when an associated client device stops responding to the AP without any power-save (PS) notification, the AP will keep sending and retrying its traffic over the air. This usually happens when the wireless client devices are moving, which is a common scenario in enterprise deployments. The client device could be sending a PS notification or a de-authentication packet before moving to a different AP, however, the AP can miss it.

To avoid useless retries over the air, the AP may put the client device into a dummy power-save after several retries even if it did not receive any PS change state. The client device traffic will be buffered in the client device's power-save queue. The AP will then send periodic probes to the client device to check if the client device responds. These periodic probes may be Null data packets (NDP) and not 802.11 probe requests. If no response is seen and the inactivity timeout triggers, the AP removes the client device from the association list.

With the introduction of the 802.11be and Multi-Link Operation (MLO), client devices can use multiple frequency bands simultaneously. This capability introduces new challenges with respect to detecting and managing the power-save states of the client device devices. There are situations where an AP might miss a power management notification on one of the links or encounter an unresponsive client device on one of the multiple bands. The traditional mechanisms for handling client device's state and power management may be insufficient for managing client devices operating in MLO mode (hereinafter referred to as MLO clients), as they do not account for the complexity of monitoring and coordinating multiple active links.

In accordance with examples of the present disclosure, proposed is a method for managing power-save states for multiple wireless links between an MLO client and an AP. In particular, the proposed examples relate to methods of detecting whether an MLO client needs to be in a dummy power-save state to enable power savings at the AP. In the MLO mode, the MLO client may communicate with the AP over two or more wireless links. In accordance with some examples of the present disclosure, if the MLO client does not respond to data traffic on one wireless link but responds to other links, the AP may set the MLO client in the dummy power-save state only on the unresponsive wireless links. The AP may continue to transmit the data traffic to the MLO client over the remaining wireless links. The AP may not use the unresponsive links in any subsequent AP transmissions. However, if the MLO client does not respond to the data traffic on any of the plurality of wireless links, the AP may assign the dummy power-save state to all the plurality of wireless links. After the dummy power-save state is assigned to the MLO client for all of the plurality of wireless links, the AP may buffer data traffic corresponding to the client device in the respective power-save queues.

In accordance with one example, the AP may transmit a first set of data packets to an MLO client. Subsequently, the AP may identify a first set of wireless links over which the MLO client is unresponsive to the first set of data packets and a second set of wireless links over which the MLO client is responsive to the first set of data packets. Then, the AP may retransmit the first set of data packets over the first set of wireless links, and continue transmitting new data packets (e.g., a second set of data packets) on the second set of wireless links. If the AP determines that a first count of retransmissions over the first set of wireless links has reached a first threshold value, the AP may configure the MLO client in a dummy power-save state for the first set of wireless links.

Further, in some examples, the AP may also be configured to effectively manage an MLO client operating in the dummy power-save state. While the MLO client is operating in the dummy power-save state (either on a subset of the wireless links or on all the wireless links), the AP may either continue to use the active wireless links or start to buffer the MLO client's traffic in its power-save queue if all the links are unresponsive. Furthermore, the AP may start sending status check messages to the MLO client over unresponsive wireless links (e.g., the first set of wireless links) for a predefined duration from the time the MLO client is configured into the dummy power-save state for the first set of wireless links. The AP may monitor the acknowledgments corresponding to one or more of the status check messages. Accordingly, if the AP receives the acknowledgment(s) from the MLO client, the AP may remove the MLO client from the dummy power-save state for one or more of the unresponsive wireless links over which it receives the acknowledgment(s). However, absent any acknowledgment from the MLO client, the AP may disable one or more of the unresponsive wireless links over which the AP has not received acknowledgment. Further, in a scenario when all of the plurality of wireless links are identified as unresponsive wireless links and the AP has not received acknowledgments corresponding to the status check messages on any of the plurality of wireless links, the AP may disassociate the MLO client (i.e., remove the MLO client from its association list).

The following detailed description refers to the accompanying drawings. It is to be expressly understood that the drawings are for the purpose of illustration and description only. While several examples are described in this document, modifications, adaptations, and other implementations are possible. Accordingly, the following detailed description does not limit disclosed examples. Instead, the proper scope of the disclosed examples may be defined by the appended claims.

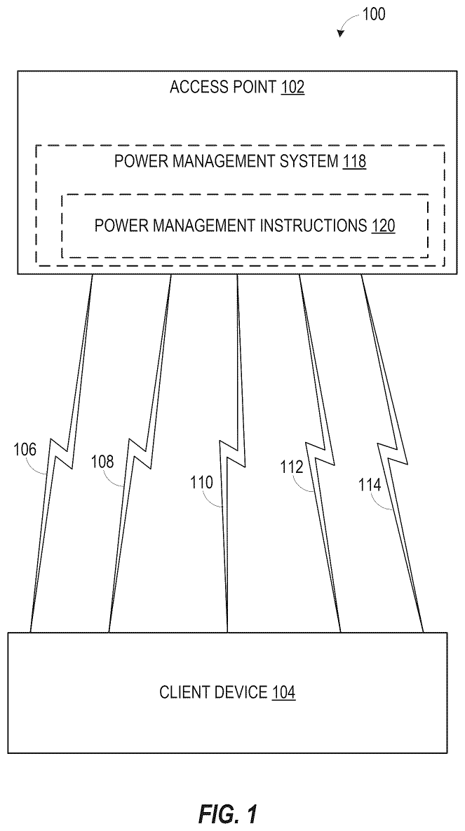

Before describing examples of the disclosed systems and methods in detail, it is useful to describe an example network installation with which these systems and methods might be implemented in various applications. FIG. 1 depicts an example networked system 100 in which various of the examples presented herein may be implemented. The networked system 100 may be implemented for any setup, for example, in a home setup or an organization, such as a business, educational institution, governmental entity, healthcare facility, or other organization. The networked system 100 may be a small-scale network of devices or a large-scale network of devices. The small-scale network of devices may be a home network, for example. The large-scale network of devices may be an organization, university, public utility space (e.g., mall, airport, railway station, bus station, stadium, etc.), or office network hosting a large number of network devices, for example.

The networked system 100 may include several devices that communicate with each other and/or with any external device or system outside the networked system 100. In the example implementation depicted in FIG. 1, the networked system 100 may include an access point (AP) 104 and a client device 102. For simplicity of illustration, the networked system 100 is shown to include a single AP (e.g., the AP 104) and a single client device (e.g., the client device 102). The use of more than one AP and client device is also envisioned within the purview of the present disclosure. Although not shown, in some examples, the networked system 100 may include additional network devices such as a network controller (e.g., a WALN controller), network switches, routers, gateways, and the like to manage and/or provide network connectivity to one or more APs present in the networked system 100.

The client device 102 may be any electronic device that has a wireless communication capability. Examples of the client device 102 may include desktop computers, laptop computers, servers, web servers, authentication servers, authentication-authorization-accounting (AAA) servers, Domain Name System (DNS) servers, Dynamic Host Configuration Protocol (DHCP) servers, Internet Protocol (IP) servers, Virtual Private Network (VPN) servers, network policy servers, mainframes, tablet computers, e-readers, netbook computers, televisions and similar monitors (e.g., smart TVs), content receivers, set-top boxes, personal digital assistants (PDAs), mobile phones, smartphones, virtual terminals, video game consoles, virtual assistants, Internet-of-Things (IoT) devices, and the like.

The AP 104 may be a networking device capable of providing wireless connectivity to the client device 102 thereby enabling the client device 102 to communicate with other electronic devices (not shown in FIG. 1). The AP 104 may include a combination of hardware, software, and/or firmware that is configured to provide wireless network connectivity to the client device. In particular, the AP 104 may act as a point of access to a local network established in the networked system 100 and/or the external network (not shown) for the client devices 102. The AP 104 may be implemented with one or more radios to help the AP 104 communicate with the client device 102 and other wireless-capable devices. Each radio of the AP 104 may operate on a respective range of radio frequency ranges, referred to as a Wi-Fi band, for example, the 2.4 GHz Wi-Fi band, 5 GHz Wi-Fi band, the 6 GHz Wi-Fi band, and so on.

Further, in some examples, the client device 102 and AP 104 may be multi-link devices (MLDs) that can support multi-link operation (MLO) in accordance with Wi-Fi standards, for example, Wi-Fi 7. MLO allows a Wi-Fi device (such as any of the client device 102 and AP 104) to simultaneously use multiple frequency bands or channels for data transmission and reception. The primary goal of MLO is to increase throughput, reduce latency, and enhance the overall reliability and robustness of the Wi-Fi connection. By leveraging multiple links, MLO can dynamically balance the load, switch to the best available link, and mitigate interference, leading to a more efficient and stable network performance. Further, with the MLD enabled, the AP 104 can establish and manage multiple links across different frequency bands (e.g., 2.4 GHZ, 5 GHZ, and 6 GHZ) with the client device 102, enabling it to take full advantage of MLO. This capability allows the AP 104 to offer better performance in terms of speed, latency, and reliability compared to traditional single-link devices.

An MLO-enabled client device, such as the client device 102 may connect to the AP 104 over one or more wireless links. For illustration purposes, the client device 102 is shown connected with the AP 104 via a plurality of wireless links 106, 108, 110, 112, and 114. By way of example, the wireless links 106, 108 may belong to a first Wi-Fi frequency band (e.g., the 2.4 GHz band), the wireless links 110, 112 may belong to a second Wi-Fi frequency band (e.g., the 5 GHz band), and the wireless link 114 may belong to a third Wi-Fi frequency band (e.g., the 6 GHz band). Each of the wireless links 106-114 represents a specific channel defined by a range of frequencies within the respective Wi-Fi frequency bands. Table 1 presented below represents an example wireless link configuration maintained by the AP. The example wireless link configuration includes information about the wireless links that are configured for MLO and respective Wi-Fi bands.

TABLE 1
Example MLO wireless link configuration

| Wireless Link | Wi-Fi Frequency Band |
|---|---|
| 106 | 2.4 GHz |
| 108 | 2.4 GHz |
| 110 | 5 GHZ |
| 112 | 5 GHZ |
| 114 | 6 GHZ |

As will be appreciated, the MLO between the AP 104 and the client device 102 may enhance the overall connectivity performance for the client device 102. If not addressed diligently, the connections over multiple wireless links may pose a challenge for an AP with respect to detecting and managing the power-save states of a client device. For instance, there may arise situations where the AP 104 might miss a power management notification on one of the wireless links 106-114 or encounter the client device 102 may become unresponsive on or more wireless links. The traditional mechanisms for handling client device's state and power management may be insufficient for managing client devices operating in MLO mode (hereinafter referred to as MLO clients), as they do not account for the complexity of monitoring and coordinating multiple active wireless links.

In accordance with examples of the present disclosure, the proposed AP 104 is configured to effectively manage power-save states for the wireless links 106-114 between the client device 102 operating in MLO mode. In some examples, to manage the power-save states for the wireless links 106-114, the AP 104 may host a power management system 118 by way of a processing resource executing the power management instructions 120 stored in a machine-readable medium of the AP 104. For illustration purposes, the power management system 118 and the power management instructions 120 are represented by the dashed outline as they represent digital entities which may be in the form of data and/or instructions that are executable by a physical processing resource, for example, a processor. By way of executing the power management instructions 120, the power management system 118 may efficiently identify a set of wireless links over which the client device 102 is unresponsive to the data traffic from the AP 104 and configure such set of wireless links in a dummy power-save state while continuing communication over the rest of the wireless links.

In accordance with some examples of the present disclosure, if the client device 102 does not respond to data traffic on one or more of the wireless links 106-114 but responds to other links, the AP 104 may set the client device 102 in the dummy power-save state only on the unresponsive wireless links. The AP 104 may continue to transmit the data traffic to the client device 102 over the remaining wireless links. For example, if the AP 104 fails to receive an acknowledgment of the transmitted data traffic on the wireless links 106 and 110, but receives the acknowledgment over the other wireless links (e.g., the wireless links 108, 112, and 114), the AP 104 may configure the client device 102 in the dummy power-save state over these unresponsive wireless links 106 and 110. However, the AP 104 may continue communicating with the client device 102 over the responsive wireless links 108, 112, and 114. In case, the client device 102 does not respond to the data traffic on any of the plurality of wireless links 106-114, the AP 104 may put the client device 102 in the dummy power-save state for all of the plurality of wireless links 106-114.

The wireless links over which the AP 104 does not receive the acknowledgment of the transmitted data traffic from the client device 102 are referred to as unresponsive wireless links (or a first set of wireless links). On the contrary, the wireless links over which the AP 104 receives the acknowledgment of the transmitted data traffic from the client device 102 are referred to as responsive wireless links (or a second set of wireless links). When the client device 102 is configured in the dummy power-save state over the unresponsive wireless links, the AP 104 may stop transmitting the data traffic to the client device 102 over the unresponsive wireless links but continue to transmit new data traffic to the client device 102 over the responsive wireless links.

Further, in some examples, the AP 104 may also be configured to effectively manage the client device 102 that is operating in the dummy power-save state. In one example, the AP 104 maintains separate power-save queues for each of the wireless links 106-114. When operated in the dummy power-save state, instead of transmitting the data traffic over the unresponsive wireless links, the AP 104 may buffer the data traffic in the respective power-save queues.

Furthermore, after the unresponsive wireless links are identified and assigned the dummy power-save state, the AP 104 may start sending status check messages to the client device 102 over the unresponsive wireless links. In some examples, the AP 104 may send the status check messages for a predefined duration from the time the client device 102 is configured into the dummy power-save state for the unresponsive wireless links. After sending the status check messages, the AP 104 may monitor the acknowledgments corresponding to one or more of the status check messages. Accordingly, if the AP 104 receives the acknowledgment(s) of the status check messages from the client device 102, the AP 104 may remove the client device 102 from the dummy power-save state for one or more of the unresponsive wireless links over which it receives the acknowledgment(s). However, absent any acknowledgment from the client device 102, the AP 104 may disable one or more of the unresponsive wireless links over which the AP 104 has not received acknowledgment.

Further, in a scenario when all of the plurality of wireless links 106-114 are identified as unresponsive wireless links and the AP 104 has not received acknowledgments corresponding to the status check messages on any of the plurality of wireless links 106-114, the AP 104 may disassociate the client device 102 (i.e., remove the client device 102 from its association list).

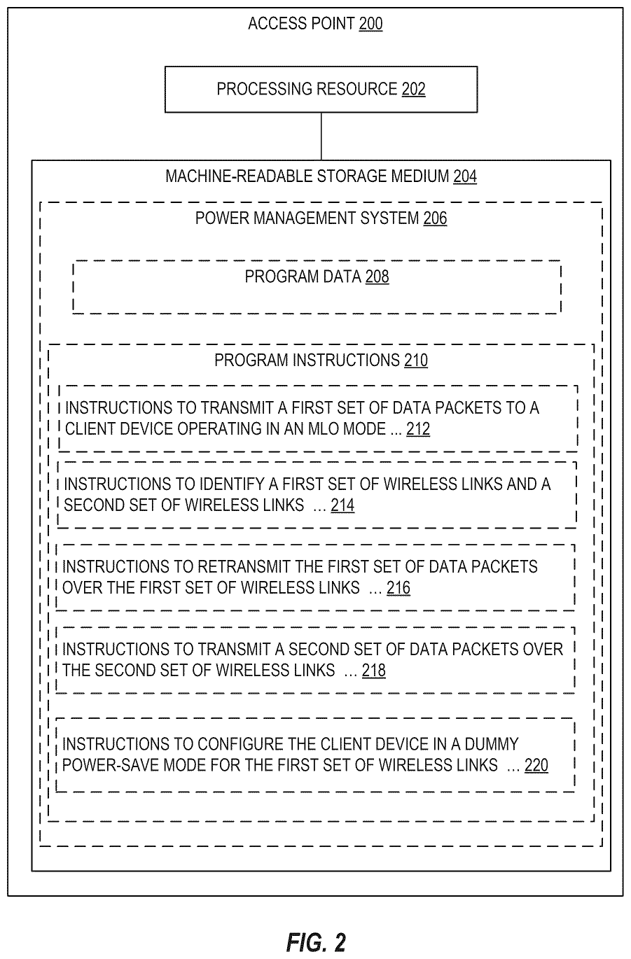

Additional details about the process of managing the wireless links 106-114 are described in conjunction with the block diagrams and flow diagrams of FIGS. 2-5.

Referring to FIG. 2, a block diagram of an example access point (AP) 200 is presented. The AP 200 of FIG. 2 may be an example representative of the AP 104 of FIG. 1. The AP 200 is configured with a power management system 206 to aid in managing save states for client devices (e.g., the client device 102). For illustration purposes, the power management system 206 and items inside the power management system 206 are represented by the dashed outline as they represent digital entities which may be in the form of data and/or instructions that are executable by a physical processing resource, for example, the processing resource 202. The AP 200 may include a processing resource 202 and/or a machine-readable storage medium 204 for the AP 200 to execute several operations as will be described in the greater details below.

The processing resource 202 may be a physical device, for example, a central processing unit (CPU), a microprocessor, a graphics processing unit (GPU), a field-programmable gate array (FPGA), application-specific integrated circuit (ASIC), other hardware devices capable of retrieving and executing instructions stored in the machine-readable storage medium 204, or combinations thereof. In one example, the processing resource 202 may fetch, decode, and execute the instructions stored in the machine-readable storage medium 204 to aid in managing power-save states of a plurality of wireless links with client devices operating in MLO mode, for example, the client device 102 of FIG. 1. As an alternative or in addition to executing the instructions, the processing resource 202 may include at least one integrated circuit (IC), control logic, electronic circuits, or combinations thereof that include a number of electronic components for performing the functionalities intended to be performed by the AP 200.

The machine-readable storage medium 204 may be non-transitory and is alternatively referred to as a non-transitory machine-readable storage medium that does not encompass transitory propagating signals. The machine-readable storage medium 204 may be any electronic, magnetic, optical, or another type of storage device that may store data and/or executable instructions. Examples of the machine-readable storage medium 204 may include Randon Access Memory (RAM), Non-volatile random-access memory (NVRAM), Electrically Erasable Programmable Read-Only Memory (EEPROM), a storage drive (e.g., Solid-State Drive or Hard Disk Drive), a flash memory device, and the like. The machine-readable storage medium 204 may be encoded with the power management system 206 to aid in managing the power-save states of the plurality of wireless links with the client devices operating in MLO mode. The power management system 206 includes program data 208 and program instructions 210 to manage the roaming of the client devices.

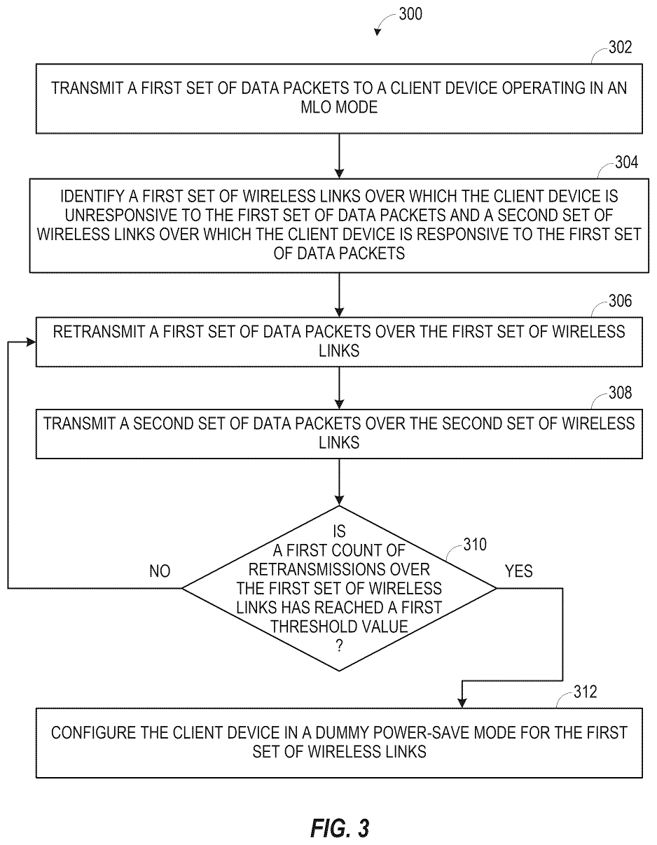

The program data 208 may store a variety of data that may be received, used, and/or generated by the processing resource 202 as the processing resource 202 executes the program instructions 210. In some examples, the program data 208 may store information such as a wireless link configuration (see Table 1, for example) for a client device specifying wireless links configured for the MLO operation and respective Wi-Fi frequency bands. Further, in some examples, the program data 208 may store information including a classification of the wireless links into a first of wireless links (i.e., unresponsive wireless links) and a second of wireless links (i.e., responsive wireless links) determined based on the client device's responsiveness over the wireless links configured for the MLO operation. Furthermore, in some examples, the program data 208 may store a wireless link power management record that may specify power-save states assigned to each of the wireless links configured for the MLO operation. In addition, the program data 208 may also maintain various counters (e.g., a first retransmission counter and a second retransmission counter-described later in conjunction with FIGS. 3-5) to keep track of the retransmission of data, and threshold values (e.g., a first threshold value and a first threshold value-described later in conjunction with FIGS. 3-5).

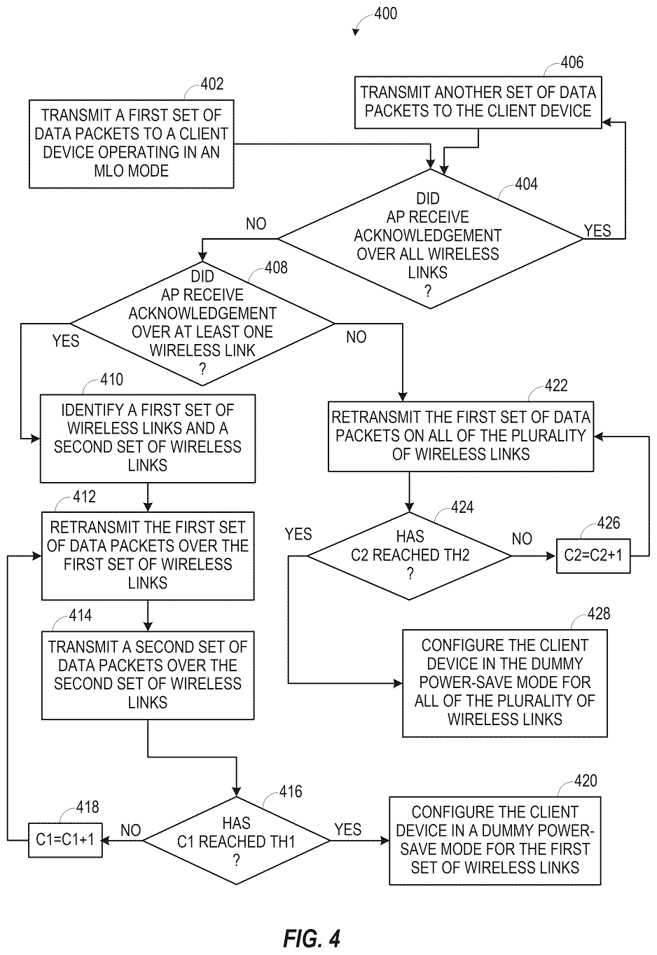

In accordance with examples consistent with the present disclosure, the AP 200 may execute the power management system 206, by way of the processing resource 202 executing the program instructions 210, to aid in managing the power-save states of the plurality of wireless links for the client device operating in MLO mode. In particular, in some examples, the processing resource 202 may execute one or more of the program instructions 210 to perform the method steps described in conjunction with FIGS. 3 and 4. For example, the program instructions 210 may include instructions 212, 214, 216, 218, and 220.

In particular, the instructions 212 when executed by the processing resource 202 may cause the processing resource 202 to transmit a first set of data packets to a client device operating in an MLO mode. Further, the instructions 214 when executed by the processing resource 202 may cause the processing resource 202 to identify a first set of wireless links over which the client device is unresponsive to the first set of data packets and a second set of wireless links over which the client device is responsive to the first set of data packets. After the first set of wireless links and the second set of wireless links have been identified, the instructions 216 when executed by the processing resource 202 may cause the processing resource 202 to retransmit the first set of data packets over the first set of wireless links. Also, the instructions 218 when executed by the processing resource 202 may cause the processing resource 202 to transmit a second set of data packets over the second set of wireless links. Moreover, the instructions 220 when executed by the processing resource 202 may cause the processing resource 202 to configure the client device in a dummy power-save state for the first set of wireless links in response to determining that a first count of retransmissions over the first set of wireless links has reached a first threshold value.

Although not shown, in some examples, the machine-readable storage medium 204 may be encoded with certain additional executable instructions to perform any other operations performed by the AP 200, without limiting the scope of the present disclosure.

Turning now to FIGS. 3-5, flowcharts of example methods for managing power-save states of a client device (e.g., the client device 102) over a plurality of wireless links are presented. The steps shown in FIGS. 3-5 may be performed by any suitable device, such as an AP 104 or 200 of FIGS. 1-2. In some examples, the suitable device may include a processing resource suitable for retrieval and execution of instructions stored in a machine-readable storage medium. The processing resource and the machine-readable storage medium may be example representatives of the processing resource 202 and the machine-readable storage medium 204 of the AP 200 of FIG. 2. As an alternative or in addition to retrieving and executing instructions, the processing resource may include one or more electronic circuits that include electronic components for performing the functionality of one or more instructions, such as an FPGA, ASIC, or other electronic circuits.

FIG. 3 depicts an example method 300 for managing power-save states for a plurality of wireless links (e.g., the wireless links 106-114) between an AP (e.g., the AP 104) and a client device (e.g., the client device 102) is presented. For ease of illustration, while describing the method 300 references are made to the networked system of FIG. 1.

At step 302, the AP may transmit a first set of data packets to a client device operating in an MLO mode. As it is understood, in the MLO mode the Wi-Fi 7 devices such as the AP and the client device may establish more than one wireless link therebetween to communicate data with each other. In particular, the MLO allows the AP and the client device to simultaneously use multiple frequency bands or channels for data transmission and reception, thereby increasing throughput, reducing latency, and enhancing the overall reliability of data communication. By way of example, the AP may transmit the first set of data packets over a plurality of wireless links, such as, the wireless links 106-114. After transmitting the first set of data packets, AP also monitors the wireless links to check for the client device's acknowledgment of the receipts of the first set of data packets.

Based on the monitoring, at step 304, AP may identify a first set of wireless links over which the client device is unresponsive to the first set of data packets and a second set of wireless links over which the client device is responsive to the first set of data packets. The first set of wireless links and the second set of wireless links are also alternatively referred to as unresponsive wireless links and responsive wireless links, respectively, with regard to the first set of data packets. In particular, after transmitting the first set of data packets, if the AP fails to receive any acknowledgment of the receipt of the first set of data packets from the client device, the AP may classify such wireless links over which the AP did not receive the acknowledgment as the first set of wireless links. Further, the AP may classify the wireless links over which the AP has received the acknowledgment as the second set of wireless links. Table 2 presented below represents an example classification of the wireless links 106-114 depending on the acknowledgment of the receipt of the first set of data packets in an example situation.

TABLE 2
Example classification of the wireless links 106-114

| Wireless | Acknowledgment | | |
|---|---|---|---|
| Link | receipt | Status | Classification |
| 106 | No | Unresponsive | First set |
| 108 | Yes | Responsive | Second set |
| 110 | No | Unresponsive | First set |
| 112 | Yes | Responsive | First set |
| 114 | Yes | Responsive | First set |

The classification of the wireless links 106-114 shown in Table 2 indicates that the AP did not receive the acknowledgment of the first set of data packets over the wireless links 106 and 110, but received the acknowledgments over the wireless links 108, 112, and 114. Accordingly, the wireless links 106 and 110 are identified as unresponsive and classified as the first set of wireless links. Further, the wireless links 108, 112, and 114 are identified as responsive and classified as the second set of wireless links.

Further, at step 306, the AP may retransmit the first set of data packets over the first set of wireless links. Further, as the AP received the acknowledgments of the receipts of the first set of data packets over the second set of wireless links, at step 308, the AP may transmit a second set of data packets (e.g., new data packets) the client device over the second set of wireless links. In some examples, the AP maintains a first retransmission counter to track the retransmissions of the data packets over the unresponsive wireless links (e.g., the first set of wireless links). Each time the AP retransmits the first set of data packets over the first set of wireless links, the AP may increment the first retransmission counter by one. For instance, after retransmitting the first set of data packets over the first set of wireless links, the AP, at step 310, may perform a check to determine if a first count of the retransmissions of the first set of data packets over the first set of wireless links has reached a first threshold value.

At step 310, if it is determined that the first count of the retransmissions has not reached the first threshold value (i.e., the first count of the retransmissions is smaller than the first threshold value), the AP may increment the first retransmission counter and execute the step 306 again. However, at step 310, if it is determined that the first count of the retransmissions has reached the first threshold value (i.e., the first count of the retransmissions is greater than or equal to the first threshold value), the AP, at step 312, may configure the client device in a dummy power-save state for the first set of wireless links. In particular, the AP may maintain a wireless link power management record that the AP may update to designate a respective power-save state. The wireless link power management record may include information about the wireless links negotiated for the MLO between the AP and the client device and respective status (indicating whether the wireless link is responsive or unresponsive) and power-save states. For example, the configuration at step 312 may entail the AP assigning the dummy power-save state to the first set of wireless links by way of updating the wireless link power management record. Table 3 presented below represents an example wireless link power management record.

TABLE 3
Example wireless link power management record

| Wireless Link | Status | Power-Save State |
|---|---|---|
| 106 | Unresponsive | Dummy Power-Save State |
| 108 | Responsive | Normal |
| 110 | Unresponsive | Dummy Power-Save State |
| 112 | Responsive | Normal |
| 114 | Responsive | Normal |

The information from the example wireless link power management record of Table 3 indicates that the client device is identified as unresponsive to the first set of data packets over the wireless links 106 and 110 (i.e., the wireless links 106 and 110 are classified as the first set of wireless links). Further, the client device is identified as responsive to the first set of data packets over the wireless links 108, 112, and 114 (i.e., the wireless links 108, 112, and 114 are classified as the second set of wireless links). Accordingly, the AP has assigned the dummy power-save state to the wireless links 106 and 110, and maintained the wireless links 108, 112, and 114 in normal mode.

Referring to FIG. 4, a flowchart of another example method 400 for managing power-save states for a plurality of wireless links (e.g., the wireless links 106-114) between an AP (e.g., the AP 104) and a client device (e.g., the client device 102) is presented. The method 400 of FIG. 4 may include certain additional steps and/or information compared to the method 300 of FIG. 3. Also, certain details of the steps already described in FIG. 4 are not repeated herein for the sake of brevity. Further, for illustration purposes, the method 400 is described in conjunction with the networked system 100 of FIG. 1.

At step 402, the AP may transmit a first set of data packets to a client device operating in an MLO mode. By way of example, the AP may transmit the first set of data packets over a plurality of wireless links, such as, the wireless links 106-114 configured for MLO with the client device. After transmitting the first set of data packets, AP also monitors the wireless links to check for the client device's acknowledgment of the receipts of transmitted data packets. In one example, the AP, at step 404, may perform a check to determine if the AP has received acknowledgment of the receipts of the transmitted data packets from all of the plurality of wireless links. At step 404, if it is determined that the AP has received acknowledgment of the receipts of the transmitted data packets from all of the plurality of wireless links, the AP, at step 406, may transmit another set of data packets to the client device over the plurality of wireless links con continue monitoring of the plurality of wireless links for the acknowledgment of the receipts of the transmitted data packets by the client device.

However, at step 404, it is determined that the AP has not received acknowledgment of the receipts of the transmitted data packets from all of the plurality of wireless links, the AP, at step 408, may perform another check to determine whether the AP has received the acknowledgment of the first set of data packets over at least one wireless link of the plurality of wireless links.

At step 408, if it is determined that the AP has received the acknowledgment of the first set of data packets over at least one wireless link, the AP, at step 410, AP may identify a first set of wireless links (also referred to as unresponsive wireless links) over which the client device is unresponsive to the first set of data packets and a second set of wireless links (also referred to as responsive wireless links) over which the client device is responsive to the first set of data packets. The first set of wireless links and the second set of wireless links are also alternatively referred to as unresponsive wireless links and responsive wireless links, respectively, with regard to the first set of data packets. In particular, after transmitting the first set of data packets, if the AP fails to receive any acknowledgment of the receipt of the first set of data packets from the client device, the AP may classify such wireless links over which the AP did not receive the acknowledgment as the first set of wireless links. Further, the AP may classify the wireless links over which the AP has received the acknowledgment as the second set of wireless links.

The classification of the wireless links 106-114 shown in Table 2 indicates that the AP did not receive the acknowledgment of the first set of data packets over the wireless links 106 and 110, but received the acknowledgment over the wireless links 108, 112, and 114. Accordingly, the wireless links 106 and 110 are identified as unresponsive and classified as the first set of wireless links. Further, the wireless links 108, 112, and 114 are identified as responsive and classified as the second set of wireless links.

Further, at step 412, the AP may retransmit the first set of data packets over the first set of wireless links. Furthermore, as the AP received the acknowledgments of the receipts of the first set of data packets over the second set of wireless links, at step 414, the AP may transmit a second set of data packets (e.g., new data packets) to the client device over the second set of wireless links. In some examples, as previously noted in conjunction with FIG. 3, the AP maintains a first retransmission counter to track a first count (C1) of the retransmissions of the data packets over the unresponsive wireless links (e.g., the first set of wireless links). After retransmitting the first set of data packets over the first set of wireless links, the AP, at step 416, may perform a check to determine if the first count (C1) of the retransmissions of the first set of data packets over the first set of wireless links has reached a first threshold value (TH1) by comparing the first count of the retransmissions with the first threshold value.

At step 416, if it is determined that the first count of the retransmissions has not reached the first threshold value (i.e., the first count of the retransmissions is smaller than the first threshold value), the AP, at step 418, may increment the first retransmission counter (i.e., a value of C1 for the next retransmission will become C1+1) and execute the step 412 again. However, at step 416, if it is determined that the first count of the retransmissions has reached the first threshold value (i.e., the first count of the retransmissions is greater than or equal to the first threshold value), the AP, at step 420, may configure the client device in a dummy power-save state for the first set of wireless links. In particular, as previously noted in conjunction with FIG. 3, the AP may maintain a wireless link power management record that the AP may update to designate a respective power-save state.

Referring again to step 408, if it is determined that the AP has not received the acknowledgment of the first set of data packets over at least one wireless link, the AP, at step 422, AP may retransmit the first set of data packets to the client device over all of the plurality of wireless links participating in the MLO. Also, in some examples, the AP maintains a second retransmission counter to track a second count (C2) of the retransmissions of the data packets over the unresponsive wireless links (e.g., all of the plurality of wireless links in this case). In particular, the AP uses the second retransmission counter in case the AP does not receive acknowledgment of the first set of data packets over any of the plurality of wireless links between the AP and the client device. After retransmitting the first set of data packets over all of the plurality of wireless links, the AP, at step 424, may perform a check to determine if the second count (C2) of the retransmissions tracked via the second retransmission counter has reached a second threshold value (TH2) by comparing the second count of the retransmissions with the second threshold value.

At step 424, if it is determined that the second count of the retransmissions has not reached the second threshold value (i.e., the second count of the retransmissions is smaller than the second threshold value), the AP, at step 426, may increment the second retransmission counter (i.e., a value of C2 for the next retransmission will become C2+1) and execute the step 422 again. However, at step 424, if it is determined that the second count of the retransmissions has reached the second threshold value (i.e., the second count of the retransmissions is greater than or equal to the second threshold value), the AP, at step 428, may configure the client device in the dummy power-save state for all of the plurality of wireless links. In particular, the AP may update the wireless link power management record (see Table 3) to assign the dummy power-save state for all of the plurality of wireless links. For example, if the client device is found unresponsive over each of the wireless links 106-114, the AP may assign the dummy power-save state to all of the wireless links 106-114.

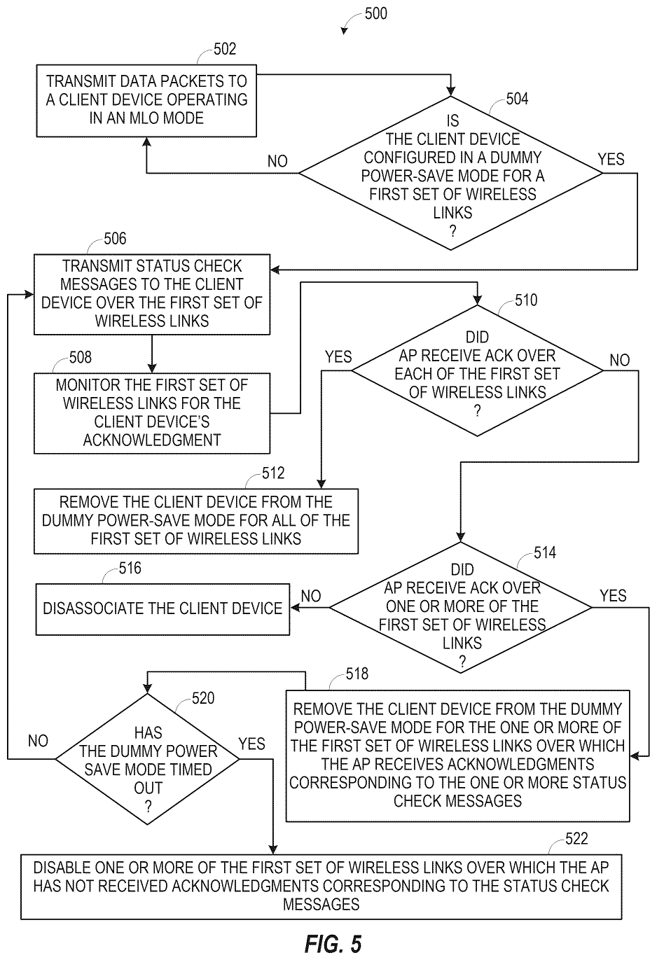

Referring to FIG. 5, a flowchart of an example method 500 for managing a client device (e.g., the client device 102 operating in the MLO mode) with one or more wireless links operating in a dummy power-save state is presented. Further, for illustration purposes, the method 400 is described in conjunction with the networked system 100 of FIG. 1.

During the operation of the AP, the AP, at step 502, may transmit data packets to the client device operating in an MLO mode (e.g., the client device 102) over one or more responsive wireless links. As previously noted, the responsive wireless links (e.g., the ones classified as the second set of wireless links, see FIGS. 3 and 4) are those wireless links over which the client device acknowledges the receipts of the data packets to the AP.

Further, at step 504, the AP may perform a check to determine whether the client device is configured in a dummy power-save state for a first set of wireless links of a plurality of wireless links. As previously noted, the first set of wireless links, also called the unresponsive links, may include wireless links over which the client device 102 has not acknowledged receipt of a first set of data packets (see steps 302 and 402 of FIGS. 3 and 4) sent to the client device from the AP. To find the unresponsive links, the AP may check the wireless link power management record (see Table 3) that the AP maintains to track the power-save states of the wireless links specified for the MLO operation with the client device. In the wireless link power management record, the AP identifies any wireless link assigned the dummy power-save state as the first set of wireless links.

At step 504, if it is determined that the client device is not configured in the dummy power-save state for the first set of wireless links, the AP may continue transmitting new data packets at step 502. However, at step 504, if it is determined that the client device is configured in the dummy power-save state for the first set of wireless links, the AP, at step 506, may transmit one or more status check messages to the client device over the first set of wireless links. In some examples, the AP may send status check messages at a preconfigured interval, either in a round-robin manner or in parallel over the first set of wireless links.

Further, at step 508, the AP may monitor the first set of wireless links for the client device's acknowledgment of the status check messages. Furthermore, at step 510, the AP may perform a check to determine if the AP has received acknowledgments (ACK) corresponding to the status check messages over each of the first set of wireless links. At step 510, if it is determined that the acknowledgments of the status check messages were received over each of the first set of wireless links, the AP, at step 512, may remove the client device from the dummy power-save state for all of the first set of wireless links. In particular, the AP may unassign the dummy power-save state from each of the first set of wireless links by updating the respective entries in the wireless link power management record (see Table 3). Such updating of the respective entries in the wireless link power management record includes the AP assigning the normal mode to each of the first set of wireless links.

At step 510, if it is determined that the acknowledgments of the status check messages were not received over each of the first set of wireless links, the AP, at step 514, may perform a check to determine whether the AP received acknowledgments of the status check messages over one or more of the first set of wireless links. At step 514, if it is determined that AP has not received acknowledgments of the status check messages over one or more of the first set of wireless links, the AP, at step 516 may disassociate the client device.

However, at step 514, if it is determined that AP has received acknowledgments of the status check messages over one or more of the first set of wireless links, the AP at step 518, may remove the client device from the dummy power-save state for the one or more of the first set of wireless links over which the AP receives acknowledgments corresponding to the one or more status check messages. In continuation of the example from FIG. 3, where the wireless links 106 and 110 were identified as the first set of wireless links (i.e., the unresponsive links), and if the client device acknowledges the status check messages over the wireless link 106, the AP may remove the client device from the dummy power-save state for the wireless link 106. In particular, the AP may assign a normal mode to the wireless link 106 and maintain the wireless link 110 in the dummy power-save state. Accordingly, after the execution of step 518, the first set of wireless links (i.e., the unresponsive links) would include the reduced number of wireless links (e.g., the wireless link 110 in the present instance).

Further, at step 520, the AP may perform a check to determine whether the dummy power-save state is timed out for the first set of wireless links. In some examples, the AP maintains a dummy power-save duration corresponding to each of the first set of wireless links. For a given unresponsive link of the first set of wireless links, the dummy power-save duration refers to the duration for which the given unresponsive link has remained in the dummy power-save state from the time the dummy power-save state is assigned to the given unresponsive link. In particular, to determine if the dummy power-save state is timed out for the first set of wireless links, the AP may check if the dummy power-save duration is smaller than a dummy power-save time-out value. The dummy power-save time-out value may be configurable. The dummy power-save state is determined to be timed out if the dummy power-save duration is smaller than the dummy power-save time-out value.

At step 520, if it is determined that the dummy power-save state has not timed out for the first set of wireless links, the AP, may move the execution to step 506 where the status check messages may be sent again to the first set of wireless links (as updated after the execution of the step 518). However, at step 520, if it is determined that the dummy power-save state has not timed out for the first set of wireless links, the AP, at step 522, may disable one or more of the first set of wireless links over which the AP has not received acknowledgments corresponding to the status check messages.

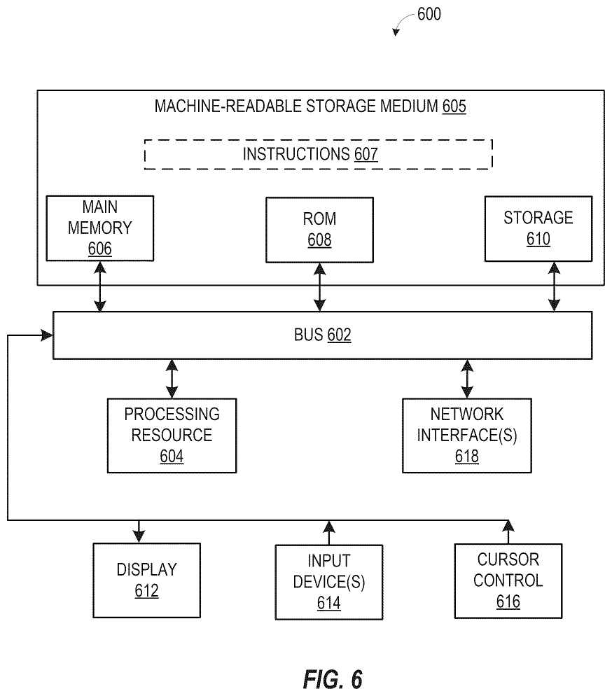

FIG. 6 depicts a block diagram of an example computing system 600 in which various of the examples described herein may be implemented. In one example, the computing system 600 may be configured to operate as an access point (AP) such as the AP 104 of FIG. 1 and can perform various operations described in one or more of the earlier drawings. In another example, the computing system 600 may be any system in a could infrastructure and capable of hosting a power management system described earlier. Examples of the devices and/or systems that may be implemented as the computing system 600 may include, wireless access points, network controllers such as a WLAN controller, routers, desktop computers, laptop computers, servers, web servers, authentication servers, AAA servers, DNS servers, DHCP servers, IP servers, VPN servers, network policy servers, mainframes, tablet computers, e-readers, netbook computers, televisions and similar monitors (e.g., smart TVs), content receivers, set-top boxes, PDAs, mobile phones, smartphones, smart terminals, dumb terminals, virtual terminals, video game consoles, virtual assistants, IoT devices, and the like.

The computing system 600 may include a bus 602 or other communication mechanisms for communicating information, a hardware processor, also referred to as processing resource 604, and a machine-readable storage medium 605 coupled to the bus 602 for processing information. In some examples, the processing resource 604 may include one or more CPUs, semiconductor-based microprocessors, and/or other hardware devices suitable for retrieval and execution of instructions stored in the machine-readable storage medium 605. The processing resource 604 may fetch, decode, and execute instructions to manage power-save states of a client device, such as the client device 102 over a plurality of wireless links, such as the wireless links 106-114 depicted in FIG. 1. As an alternative or in addition to retrieving and executing instructions, the processing resource 604 may include one or more electronic circuits that include electronic components for performing the functionality of one or more instructions, such as an FPGA, an ASIC, or other electronic circuits.

In some examples, the machine-readable storage medium 605 may include a main memory 606, such as a RAM, cache, and/or other dynamic storage devices, coupled to the bus 602 for storing information and instructions to be executed by the processing resource 604. The main memory 606 may also be used for storing temporary variables or other intermediate information during the execution of instructions to be executed by the processing resource 604. Such instructions, when stored in storage media accessible to the processing resource 604, render the computing system 600 into a special-purpose machine that is customized to perform the operations specified in the instructions. The machine-readable storage medium 605 may further include a read-only memory (ROM) 608 or other static storage device coupled to the bus 602 for storing static information and instructions for the processing resource 604. Further, in the machine-readable storage medium 605, a storage device 610, such as a magnetic disk, optical disk, or USB thumb drive (Flash drive), etc., may be provided and coupled to the bus 602 for storing information and instructions.

In some examples, the bus 602 of the computing system 600 may be coupled to a display 612, such as a liquid crystal display (LCD) (or touch-sensitive screen), for displaying information to a computer user. In some examples, an input device 614, including alphanumeric and other keys (physical or software generated and displayed on a touch-sensitive screen), may be coupled to the bus 602 for communicating information and command selections to the processing resource 604. Also, in some examples, another type of user input device such as a cursor control 616 may be connected to the bus 602. The cursor control 616 may be a mouse, a trackball, or cursor direction keys. The cursor control 616 may communicate direction information and command selections to the processing resource 604 for controlling cursor movement on the display 612. In some other examples, the same direction information and command selections as cursor control may be implemented via receiving touches on a touch screen without a cursor.

In some examples, the computing system 600 may include a user interface module to implement a GUI that may be stored in a mass storage device as executable software codes that are executed by the computing device(s). This and other modules may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables.

The computing system 600 also includes a network interface 618 coupled to bus 602. The network interface 618 provides a two-way data communication coupling to one or more network links that are connected to one or more local networks. For example, the network interface 618 may be an integrated services digital network (ISDN) card, cable modem, satellite modem, or a modem to provide a data communication connection to a corresponding type of telephone line. As another example, the network interface 618 may be a local area network (LAN) card or a wireless communication unit (e.g., Wi-Fi chip/module).

In some examples, the machine-readable storage medium 605 (e.g., one or more of the main memory 606, the ROM 608, or the storage device 610) stores instructions 607 (marked with dashed outline) which when executed by the processing resource 604 may cause the processing resource 604 to execute one or more of the methods/operations described hereinabove. The instructions 607 may be stored on any of the main memory 606, the ROM 608, or the storage device 610. In some examples, the instructions 607 may be distributed across one or more of the main memory 606, the ROM 608, or the storage device 610. In some examples, the instructions 607 when executed by the processing resource 604 may cause the processing resource 604 to perform one or more of the methods described in any of FIGS. 3-5.

Terms and phrases used in this document, and variations thereof, unless otherwise expressly stated, should be construed as open-ended as opposed to limiting. As examples of the foregoing, the term “including” should be read as meaning “including, without limitation” or the like. The term “example” is used to provide exemplary instances of the item in the discussion, not an exhaustive or limiting list thereof. The terms “a” or “an” should be read as meaning “at least one,” “one or more” or the like. The presence of broadening words and phrases such as “one or more,” “at least,” “but not limited to” or other like phrases in some instances shall not be read to mean that the narrower case is intended or required in instances where such broadening phrases may be absent. Further, the term “and/or” as used herein refers to and encompasses any and all possible combinations of the associated listed items. It will also be understood that, although the terms first, second, third, etc., may be used herein to describe various elements, these elements should not be limited by these terms, as these terms are only used to distinguish one element from another unless stated otherwise or the context indicates otherwise.

What is claimed is:

1. A method comprising:
transmitting, by an access point (AP) over a plurality of wireless links, a first set of data packets to a client device operating in a Multi-Link Operation (MLO) mode;
identifying, by the AP, a first set of wireless links of the plurality of wireless links over which the client device is unresponsive to the first set of data packets and a second set of wireless links of the plurality of wireless links over which the client device is responsive to the first set of data packets;
retransmitting, by the AP, the first set of data packets over the first set of wireless links;
transmitting, by the AP, a second set of data packets over the second set of wireless links; and
configuring, by the AP, the client device in a dummy power-save state for the first set of wireless links in response to determining that a first count of retransmissions over the first set of wireless links has reached a first threshold value.

2. The method of claim 1, wherein:
identifying the first set of wireless links comprises determining, by the AP, that the AP has not received acknowledgment of the first set of data packets from the client device over the first set of wireless links; and
identifying the second set of wireless links comprises determining, by the AP, that the AP has received the acknowledgment of the first set of data packets from the client device over the second set of wireless links.

3. The method of claim 2, further comprising retransmitting, by the AP, the first set of data packets over the plurality of wireless links in response to determining that the client device has not acknowledged receipt of the first set of data packets on any of the first set of wireless links and the second set of wireless links.

4. The method of claim 3, further comprising configuring, by the AP, the client device in the dummy power-save state for each of the plurality of wireless links responsive to determining that a second count of retransmissions over the plurality of wireless links has reached a second threshold value.

5. The method of claim 1, further comprising transmitting, by the AP, one or more status check messages to the client device over the first set of wireless links within a predefined duration from a time the client device is configured into the dummy power-save state.

6. The method of claim 5, further comprising removing the client device from the dummy power-save state for one or more of the first set of wireless links over which the AP receives acknowledgments corresponding to the one or more status check messages.

7. The method of claim 5, further comprising disabling one or more of the first set of wireless links over which the AP has not received acknowledgments corresponding to the one or more status check messages.

8. The method of claim 5, further comprising de-associating the client device if the client device is unresponsive over all of the plurality of wireless links and the AP has not received acknowledgments corresponding to the one or more status check messages on any of the plurality of wireless links.

9. The method of claim 1, further comprising storing, after the client device is configured into the dummy power-save state, new data packets corresponding to the first set of wireless links into respective power-save data transmission buffers.

10. An access point (AP) comprising:
a non-transitory machine-readable storage medium storing instructions; and
a processing resource coupled to the non-transitory machine-readable storage medium, wherein the processing resource is configured to execute one or more of the instructions to:
transmit a first set of data packets, over a plurality of wireless links, to a client device operating in a Multi-Link Operation (MLO) mode;
identify a first set of wireless links of the plurality of wireless links over which the client device is unresponsive to the first set of data packets and a second set of wireless of the plurality of wireless links over which the client device is responsive to the first set of data packets;
retransmit the first set of data packets over the first set of wireless links;
transmit a second set of data packets over the second set of wireless links; and
configure the client device in a dummy power-save state for the first set of wireless links in response to determining that a first count of retransmissions over the first set of wireless links has reached a first threshold value.

11. The AP of claim 10, wherein the processing resource is configured to execute one or more of the instructions to:
identify the first set of wireless links comprises determining, by the AP, that the AP has not received acknowledgment of the first set of data packets from the client device over the first set of wireless links; and
identify the second set of wireless links comprises determining, by the AP, that the AP has received the acknowledgment of the first set of data packets from the client device over the second set of wireless links.

12. The AP of claim 11, wherein the processing resource is configured to execute one or more of the instructions to retransmit the first set of data packets over the plurality of wireless links in response to determining that the client device has not acknowledged receipt of the first set of data packets on any of the plurality of wireless links.

13. The AP of claim 12, wherein the processing resource is configured to execute one or more of the instructions to configure the client device in the dummy power-save state for each of the plurality of wireless links responsive to determining that a second count of retransmissions over the plurality of wireless links has reached a second threshold value.

14. The AP of claim 10, wherein the processing resource is configured to execute one or more of the instructions to transmit, within a predefined duration, one or more status check messages to the client device over the first set of wireless links within a predefined duration from a time the client device is configured into the dummy power-save state.

15. The AP of claim 14, wherein the processing resource is configured to execute one or more of the instructions to remove the client device from the dummy power-save state for one or more of the first set of wireless links over which the AP receives acknowledgments corresponding to the one or more status check messages.

16. The AP of claim 14, wherein the processing resource is configured to execute one or more of the instructions to disable one or more of the first set of wireless links over which the AP has not received acknowledgments corresponding to the one or more status check messages.

17. The AP of claim 14, wherein the processing resource is configured to execute one or more of the instructions to de-associate the client device if the client device is unresponsive over all of the plurality of wireless links and the AP has not received acknowledgments corresponding to the one or more status check messages on any of the plurality of wireless links.

18. A method comprising:
determining, by an access point (AP), whether a client device operating in a Multi-Link Operation (MLO) mode is configured in a dummy power-save state for a first set of wireless links of a plurality of wireless links, wherein the first set of wireless links comprises wireless links over which the client device has not acknowledged receipt of a first set of data packets sent to the client device from the AP;
transmitting, by the AP, one or more status check messages to the client device over the first set of wireless links within a predefined duration from a time the client device is configured into the dummy power-save state for the first set of wireless links; and
removing, by the AP, the client device from the dummy power-save state for one or more of the first set of wireless links over which the AP receives acknowledgments corresponding to the one or more status check messages.

19. The method of claim 18, further comprising disabling, by the AP, one or more of the first set of wireless links over which the AP has not received acknowledgments corresponding to the one or more status check messages.

20. The method of claim 18, further comprising:
transmitting, by the AP over the plurality of wireless links, the first set of data packets to the client device;
identifying, by the AP, the first set of wireless links over which the client device is unresponsive to the first set of data packets and a second set of wireless links over which the client device is responsive to the first set of data packets;
retransmitting, by the AP, the first set of data packets over the first set of wireless links;
transmitting, by the AP, a second set of data packets over the second set of wireless links; and
configuring, by the AP, the client device in the dummy power-save state for the first set of wireless links in response to determining that a first count of retransmissions over the first set of wireless links has reached a first threshold value.
